(19) United States
(12) Patent Application Publication
(10) Pub. No.: US 2007/0175093 A1
(43) Pub. Date: Aug. 2, 2007

(54) Gnat-trapping hydroponic lid and wrapper and method for use thereof

(76) Inventor: Glen Aery, Redondo Beach, CA (US)

Correspondence Address: Karl M. Steins;Steins & Associates, Suite 120, 2333 Camino del Rio South, San Diego, CA, 92108, US

(21) Appl. No.: 11/346,882

(22) Filed: Feb. 2, 2006

(51) Int. Cl. A01G 13/02

(52) U.S. Cl. 47/31.1

(57) ABSTRACT

A Gnat-trapping Hydroponic Lid and Wrapper and Method of Use Thereof. The Lid is configured to be placed over the top of a hydroponic cube or hydroponic basket. The top surface of the lid is best if colored in a manner that attracts gnats and other flying insects. The bottom surface of the lid is best if black or other dark color that will inhibit mold formation. There are one or more holes in the lid to accommodate a seedling growing therethrough and possibly an irrigation tube going down into it. A connecting slit running between an edge of the lid and the seedling aperture so that the lid can be removed without damaging the seedling. The lid should has an adhesive applied to its top surface that will capture gnats and other flying insects landing thereon. In another embodiment, a supplemental sheath is wrapped around a hydroponic cube. This inner sheath has the gnat adhesive applied to it. There is then a second (outer) protective sheath applied around the cube, over the top of the gnat adhesive.

### BACKGROUND OF THE INVENTION

1. Field of the Invention

This invention relates to hothouse growing accessories and, more specifically, to a Gnat-trapping Hydroponic Lid and Wrapper and Method of Use Thereof.

2. Description of Related Art

A vast majority of the produce consumed today began its life, and most time spent its entire life in a hydroponic growing habitat, commonly referred to as a “hothouse.” While there are several approaches to starting plantings, two common approaches are through the use of a hydroponic cube and a hydroponic basket. FIG. 1 is a perspective view of a conventional seedling growing assembly using a hydroponic cube 10.

The cube 10 is a block of stonewool 12 or other absorbent material that is firm yet retains water and allows the roots of the growing seedling to grow into it. The cube 10 typically has a protective wrapper 16 surrounding its sides to keep the stonewool cube 12 in a cohesive block shape. The wrapper 16 generally does not cover either the top surface or the bottom surface of the cube 10 to allow for water and nutrient addition from either the top or the bottom.

The stonewall 12 has a reservoir 14 formed in its top surface, which is where the seed is placed when planting/starting the growth. As the seedling 18 grows, it extends as shown up from the reservoir. When the seedling 18 has achieved an adequate size, the entire cube 10 with the seedling 18 grown into it can be transferred to a pot of dirt or other material.

FIG. 2 is a perspective view of a conventional hydroponic basket 20. The basket 20 is formed with many holes or perforations on its side and bottom walls, and is generally filled with rocks 24 that can simply be rock material, or some absorbent material, such as formed stonewool. The basket 20 generally has a flat upper rim 22.

In use, the seed is placed into the basket 20 along with the rocks 24. The rocks 24 are loosely retained within the basket 20, and therefore allow the seedling 18 to protrude out of the rocks 24 as it grows. When of sufficient size, the seedling 18 can actually be removed from the basket 20 for planting, leaving the rocks 24 for reuse for another seed planting.

One major problem experienced in the hydroponic growing environment is related to the infestation of the plants with fungus gnats. Fungus gnats apparently find the hydroponic cubes and baskets very attractive. The mature gnats land atop the cube or basket, and lay eggs. The larvae from the hatching eggs then infests the root structure of the seedlings, thereby severely retarding growth and usually killing the plant. This can become a huge problem because infestations will frequently affect an entire hydroponic growing zone and can kill all of the plants growing there.

There are only three current methods for avoiding fungus gnat infestation: (1) the application of pesticides, which can be undesirable due to their toxicity, expense, and deleterious effect on the plants; (2) the use of gnat traps, which are hanging boxes coated with glue-like material for attracting gnats that are then irretrievably stuck to the adhesive; or (3) destroying the infested seedlings and their hydroponic cube or basket to avoid the spread of the problem.

All three of these approaches has its weaknesses, which is why the fungus gnat is a major enemy of the hydroponic growing industry. What is needed is a device and method for preventing fungus gnat infestation of hydroponic growing stations that does not add excessive cost or involve the use of harmful pesticides.

### SUMMARY OF THE INVENTION

In light of the aforementioned problems associated with the prior devices and methods, it is an object of the present invention to provide a Gnat-trapping Hydroponic Lid and Wrapper and Method of Use Thereof. The Lid should be configured to be placed over the top of a hydroponic cube or hydroponic basket. The top surface of the lid should be colored in a manner that attracts gnats and other flying insects. The bottom surface of the lid should be black or other dark color that will inhibit mold formation. There should be one or more holes in the lid to accommodate a seedling growing therethrough and possibly an irrigation tube going down into it. There should be a connecting slit running between an edge of the lid and the seedling aperture so that the lid can be removed without damaging the seedling. The lid should have an adhesive applied to its top surface that will capture gnats and other flying insects landing thereon. In another embodiment, a supplemental sheath is wrapped around a hydroponic cube. This inner sheath should have the gnat adhesive applied to it. There should then be a second (outer) protective sheath applied around the cube, over the top of the gnat adhesive.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional hydroponic cube-based hothouse grower setup;

FIG. 2 is a perspective view of a conventional hydroponic basket-based hothouse grower setup;

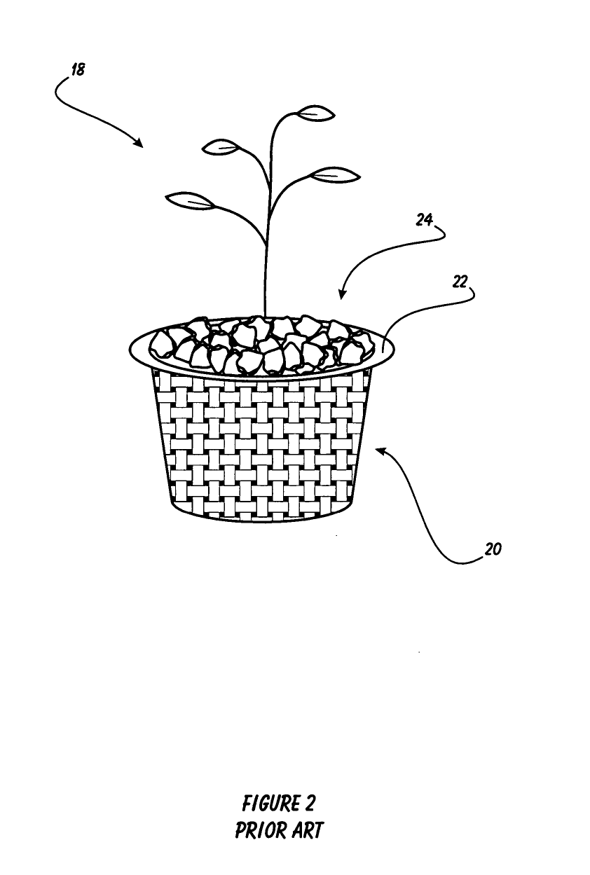

FIGS. 3A and 3B are perspective views of a preferred embodiment of the gnat-trapping lid of the present invention;

FIGS. 4A and 4B are perspective views of a second preferred embodiment of the gnat-trapping lid of the present invention;

FIGS. 5A and 5B are perspective views of a hydroponic cube-based hothouse setup employing the cap of FIGS. 3A and 3B; and

FIG. 6 is a perspective view of a gnat-trapping hydroponic cube of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Gnat-trapping Hydroponic Lid and Wrapper and Method of Use Thereof.

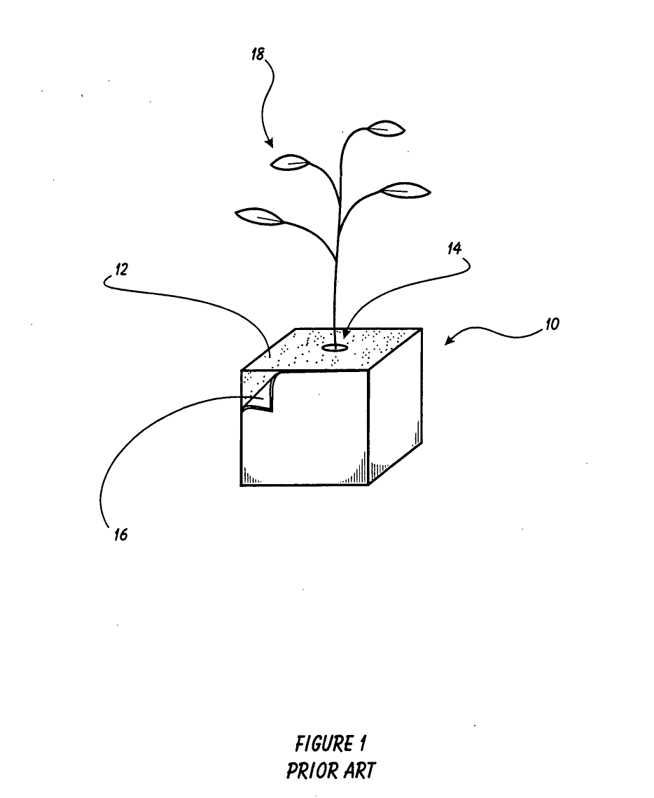

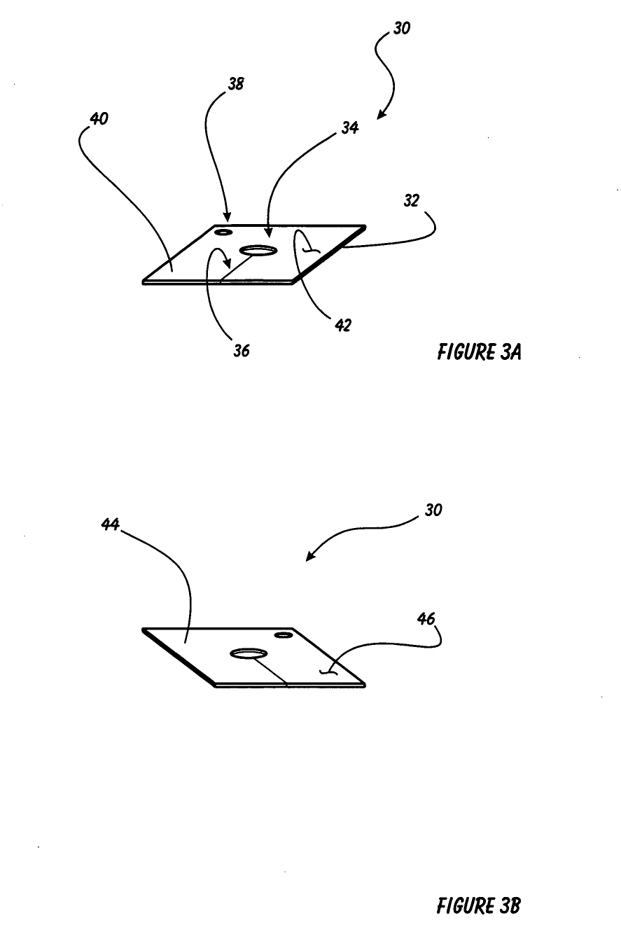

The present invention can best be understood by initial consideration of FIGS. 3A and 3B. FIGS. 3A and 3B are perspective views of a preferred embodiment of the gnat-trapping lid 30 of the present invention. The lid 30 is made from a thin sheet 32 of material, such as plastic or other somewhat durable (and preferably flexible) material. There is a seedling aperture 34 formed generally at the center of the sheet 32 that is configured to align with the reservoir formed in the hydroponic cube (see FIG. 1).

There is a connecting slit 36 penetrating the sheet 32, and interconnecting the seedling aperture 34 with one perimeter edge of the sheet 32. The slit 36 enables the lid 30 to be removed from the cube once the seedling has grown through the seedling aperture 34 without damaging the seedling.

An irrigation aperture 38 may be formed in the sheet 32 to allow for a drip irrigation tube to be inserted through it for administering liquid to the seedling during growth.

What is truly unique about the lid 30 is that the top surface 40 is substantially covered with a gnat adhesive 42. This adhesive 42 is of the type conventionally used in hanging gnat traps, and is well-known in the field. It has never, however, been used in such close proximity to the seedlings (on a lid covering the cube), but instead has only been used for area-wide protection of the hydroponic room or greenhouse. Furthermore, the top surface 40 will have a color applied to it that has been found to be attractive to gnats—either bright yellow or bright blue.

The result of putting the attractive color and gnat adhesive right at the base of the seedling is to prevent access to the seedling's roots. The mature gnats are attracted to the attracting color and are then mired in the gnat adhesive 42 before they can reach the roots. Since the gnats are attracted to the seedling and its roots even without the attracting color, it is expected that this approach will be essentially foolproof. A much higher percentage of the gnats will be caught by the lid 30 then would have ever been caught by a conventional hanging gnat trap.

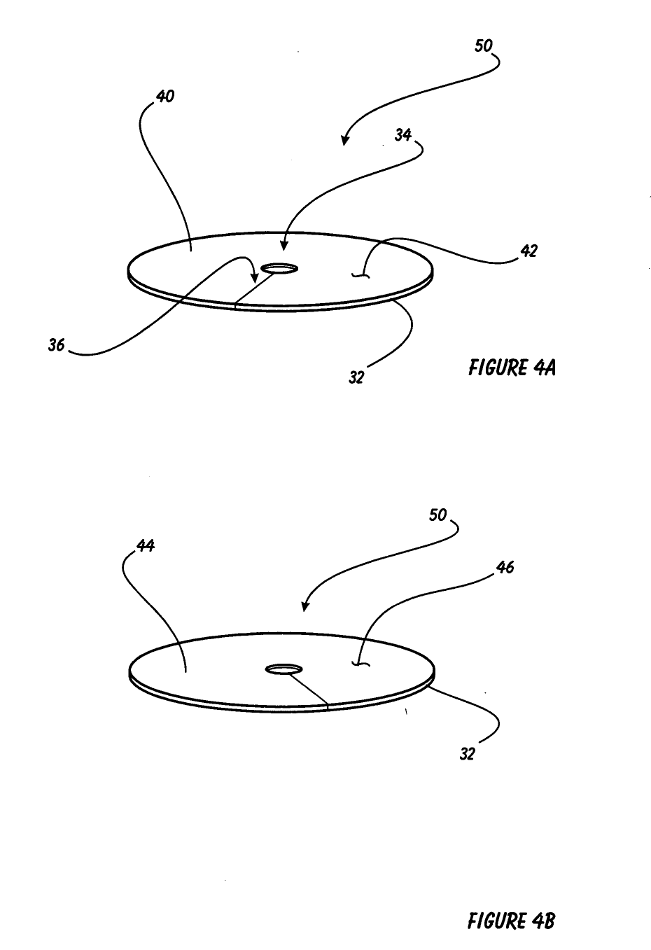

The bottom surface 44 of the sheet 32 should display a black or other dark color 46 in order to absorb incident light and therefore retard mold formation under the lid 30 and in an around the seedling's root structure. If we now turn to FIGS. 4A and 4B, we can examine another type of lid.

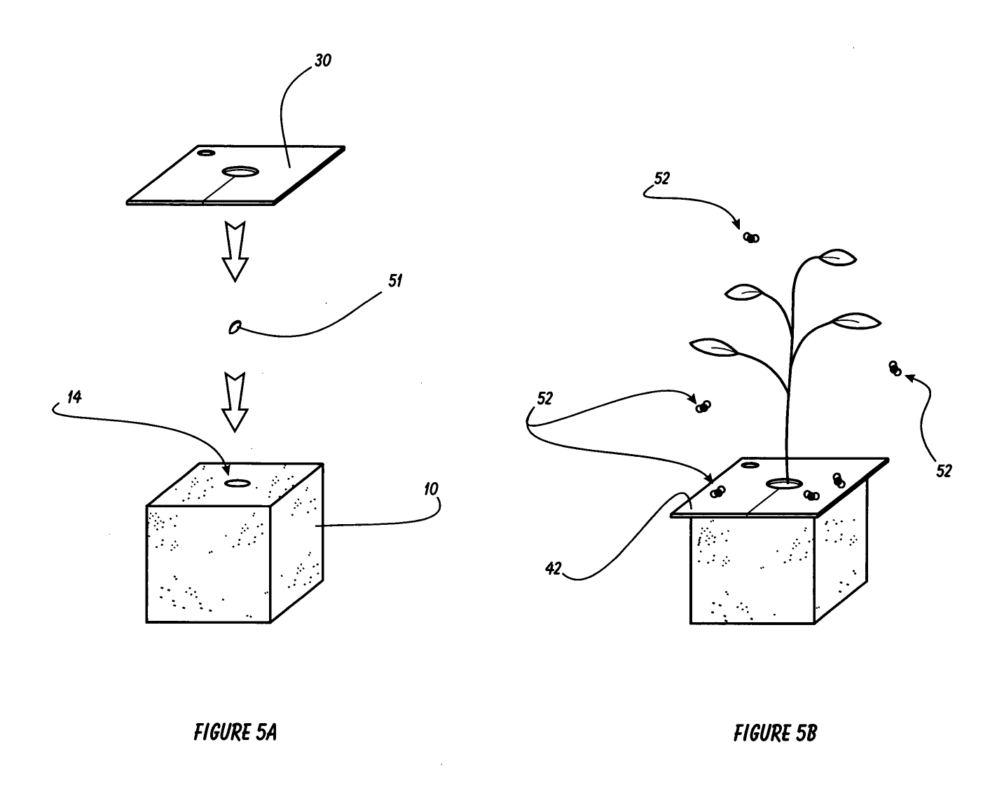

FIGS. 4A and 4B are perspective views of a second preferred embodiment of the gnat-trapping lid 50 of the present invention. As should be apparent, this lid 50 is designed to be used in conjunction with a hydroponic basket. The sheet 32 has a seedling aperture 34, and a connecting slit 36 interconnecting the aperture 34 with the peripheral edge of the sheet 32. The top surface 40 is colored to attract gnats (bright yellow or bright blue), and has gnat adhesive 42 dispersed across it. The bottom surface 44 is colored black 46 (or other dark color) to retard mold formation. The reader may note that there is no irrigation aperture in this lid 50; in most cases, hydroponic baskets are placed in an irrigation tray, rather than fed with irrigation tubes. If we turn to FIGS. 5A and 5B, we can examine how the device is installed on a hydroponic cube.

FIGS. 5A and 5B are perspective views of a hydroponic cube-based hothouse setup employing the lid 30 of FIGS. 3A and 3B. First, a seed 51 is placed into the reservoir 14 formed in the top of the cube 10, next the lid 30 is laid atop the cube 10. While this could be done in reverse order, the relative small diameter of the seedling aperture formed in the lid 30, may dictate that the seed 51 be inserted prior to covering the reservoir 14 with the lid 30.

Once the seedling grows up through the seedling aperture, the gnats 52 (and all other flying or crawling insects in the area) will become stuck in the gnat adhesive 42 spread on the top surface of the lid 30. As a result, they will be prevented from infesting the seedling's roots with eggs and larvae.

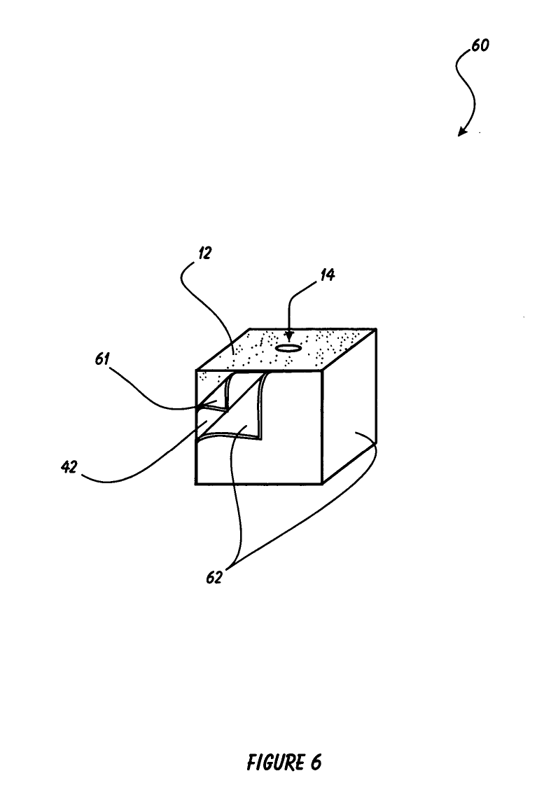

FIG. 6 is a perspective view of a gnat-trapping hydroponic cube 60 of the present invention. The cube 60 combines the benefits of the conventional hydroponic cube with the close-proximity gnat trapping ability provided by the lid described previously. The cube 60 has a stonewool cube 12 with a central reservoir 14 formed within it. Instead of the conventional plastic wrapper surrounding the cube 12, however, this cube 60 is wrapped in a first sheath 61 of thin plastic having a coating of gnat adhesive 42. The sheath 61 could also be inscribed with the bright yellow or bright blue color believed to attract flying insects. To prevent the adhesive 42 getting stuck to everything during handling, there is a protective sheet 62 of plastic wrapped around the cube 60. The protective sheet 62 may be treated on its inner surface to make it release from the adhesive 42 when the cube 60 is put into service. The user then need simply to pull off the protective sheet 62, and then effectuate the planting of the seed in the block 12.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A lid for hydroponic vessels, comprising:
a thin sheet, comprising:
a top surface and a bottom surface and a peripheral edge;
a central aperture formed through said sheet; and
a gnat adhesive exposed on said top surface.

2. The lid of claim 1, wherein said bottom surface displays a dark color.

3. The lid of claim 2, wherein said dark color is black.

4. The lid of claim 3, wherein said sheet further comprises a connecting slit interconnecting said central aperture with said peripheral edge.

5. The lid of claim 4, wherein said top surface displays a bright yellow color.

6. The lid of claim 4, wherein said top surface displays a bright blue color.

7. The lid of claim 4, where said sheet further comprises an irrigation aperture formed therethrough in spaced relation to said central aperture.

8. A hydroponic cube assembly, comprising:
a block of hydroponic absorbant material defined by a top surface, a bottom surface, and bounded by at least a side surface;
a first sheath wrapped around said side surface, said sheath having an inner side and an outer exposed side; and
an adhesive applied to said outer exposed side of said sheath whereby said adhesive faces outwardly.

9. The assembly of claim 8, further comprising a protective sheet wrapped around said first sheath to substantially cover said outwardly-facing adhesive.

10. The assembly of claim 9, wherein said outer exposed side of said sheath displays a bright yellow color.

11. The assembly of claim 9, wherein said outer exposed side of said sheath displays a bright blue color.

12. The assembly of claim 9, wherein said inner side of said sheath displays a black color.

13. The assembly of claim 12, wherein said outer exposed side of said sheath displays a bright yellow color.

14. The assembly of claim 12, wherein said outer exposed side of said sheath displays a bright blue color.

15. A flat sheet-like cover, comprising:
a thin sheet, comprising:
a top surface and a bottom surface and a peripheral edge;
a central aperture formed through said sheet; and
a gnat adhesive exposed on said top surface.

16. The lid of claim 15, wherein said sheet further comprises a connecting slit interconnecting said central aperture with said peripheral edge.

17. The lid of claim 16, wherein said top surface displays a bright yellow color.

18. The lid of claim 16, wherein said top surface displays a bright blue color.

19. The lid of claim 16, where said sheet further comprises an irrigation aperture formed therethrough in spaced relation to said central aperture.

20. The lid of claim 19, wherein said bottom surface displays a dark color.
